(19) United States
(12) Patent Application Publication
(10) Pub. No.: US 2008/0040091 A1
(43) Pub. Date: Feb. 14, 2008

(54) METHOD AND APPARATUS OF SIMULATING A SEMICONDUCTOR INTEGRATED CIRCUIT AT GATE LEVEL

(76) Inventors: Tak-Yung Kim, Seoul (KR); Sun-Yung Jang, Seoul (KR); Hyoung-Soo Song, Yongin-si (KR)

Correspondence Address: F. CHAU & ASSOCIATES, LLC, 130 WOODBURY ROAD, WOODBURY, NY, 11797, US

(21) Appl. No.: 11/776,174

(22) Filed: Jul. 11, 2007

(30) Foreign Application Priority Data
Aug. 8, 2006 (KR) 2006-74455

(51) Int. Cl. G06F 17/50

(52) U.S. Cl. 703/18

(57) ABSTRACT

A method of simulating a semiconductor integrated circuit (IC) at gate level includes providing a net list including information about a variable power source and a variable ground source, providing a circuit model including the variable power source and the variable ground source, and simulating the net list by using the circuit model at gate level.

### CROSS-REFERENCE TO RELATED APPLICATIONS

This application claims priority under 35 USC §119 to Korean Patent Application No. 200674455, filed on Aug. 8, 2006 in the Korean Intellectual Property Office (KIPO), the disclosure of which is incorporated by reference herein in its entirety.

### BACKGROUND OF THE INVENTION

1. Technical Field

The present disclosure relates to simulating a semiconductor integrated circuit (IC), and more particularly to a method and an apparatus of simulating the semiconductor IC at gate level.

2. Discussion of Related Art

A chip may be designed at a register transfer level. Hardware Description Language (HDL) is used for the design at the register transfer level. The design may be analyzed for a gate level description when the chip is designed at the register transfer level.

An output pin state may be determined based on an input pin state when the chip is analyzed at the gate level. However the output pin state may be affected by a power state and a ground state. For example, when simulating designs of multiple powers or designs of power-gating, the chip may be simulated erroneously.

Thus, there is a need for a method and an apparatus of simulating a semiconductor IC at gate level for the designs of multiple powers or power-gating designs.

### SUMMARY OF THE INVENTION

An exemplary embodiment of the present invention provides a method for simulating a semiconductor integrated (IC) at gate level. The method includes providing a net list including information about a variable power source and a variable ground source, providing a circuit model including the variable power source and the variable ground source, and simulating the net list using the circuit model at gate level.

The method may further include determining whether the net list is operating normally based on a result of the simulating. A result of the simulating may be based on states of the variable power source and the variable ground source. The simulating may use Verilog Hardware Description Language (HDL). The simulating may use Very High Speed Specific Integrated Circuit Hardware Description Language (VHDL).

An exemplary embodiment of the present invention provides an apparatus for simulating a semiconductor integrated circuit (IC) at gate level. The apparatus includes a database, a modeling tool, a simulator. The database is configured to store information about a variable power source and a variable ground source. The modeling tool is configured to provide a circuit model including the variable power source and the variable ground source. The simulator is configured to simulate the net list at gate level by using the circuit model.

An output of the simulator may be based on states of the variable power source and the ground source. The simulator may use Verilog Hardware Description Language (HDL). The simulator may use Very High Speed Specific Integrated Circuit Hardware Description Language (VHDL).

An exemplary embodiment of the present invention provides a method for optimizing an integrated circuit (IC) chip. The method includes providing a design of an IC chip including information about a variable power source and variable ground sources forming at least one voltage island by partitioning elements of the IC chip design according to similarities in voltage requirements of the elements of the IC chip and timing of the variable power sources and the variable ground sources simulating each voltage island at gate level to output a list including information about the voltage requirements and timing of each voltage island, and optimizing the design of the 10 chip based on the list.

The method may include placing circuit elements on the IC chip. The simulating of each voltage island may include providing a net list including information about a corresponding one of the variable power and ground sources and simulating the voltage island by using the net list at gate level. A result of the simulating of the voltage island may be based on states of the corresponding one of the variable power and ground sources.

An exemplary embodiment of the present invention provides a method of designing an IC chip. The method includes providing a circuit model including a variable power source and a variable ground source., providing a net list including information about the variable power source and the variable ground source, simulating the net list by using the circuit model at gate level, determining whether the net list is operating normally based on a result of the simulating, and generating a lay-out for the net list when the net list is operating normally.

A result of the gate level simulation may be based on states of the variable power source and the variable ground source. The simulating of the net list may be performed by using Verilog Hardware Description Language (HDL). The simulating of the net list may be performed by using Very High Speed Specific Integrated Circuit Hardware Description Language (VHDL).

### BRIEF DESCRIPTION OF THE DRAWINGS

FIG. 1 is a flow chart illustrating a method of simulating a semiconductor integrated circuit (IC) at gate level according to an exemplary embodiment of the present invention.

FIG. 2A is a diagram illustrating a circuit model of a buffer that is powered by a variable power source and a variable ground source according to an exemplary embodiment of the present invention.

FIG. 2B is a diagram illustrating a circuit model of a buffer that is not powered by a variable power source and a variable ground source.

FIG. 3A is a diagram illustrating an example of Verilog Hardware Description Language (HDL) corresponding to the buffer of FIG. 2A.

FIG. 3B is a diagram illustrating an example of Verilog Hardware Description Language (HDL) corresponding to the buffer of FIG. 28.

FIGS. 4A and 48 are diagrams illustrating circuit models of a p-type metal-oxide semiconductor (PMOS) switch and an n-type metal-oxide semiconductor (NMOS) switch according to exemplary embodiments of the present invention.

FIGS. 5A and 5B are diagrams illustrating examples of Verilog HDL corresponding to the PMOS switch and the NMOS switch of FIGS. 4A and 4B, respectively.

FIG. 6 is a diagram illustrating a circuit model of the PMOS switch of FIG. 4A and the NMOS switch of FIG. 48 that are employed to the buffer of FIG. 2A.

FIG. 7 is a block diagram illustrating an apparatus for simulating a semiconductor IC at gate level according to an exemplary embodiment of the present invention.

FIG. 8 is a flow chart illustrating a method of designing an IC according to an exemplary embodiment of the present invention.

FIG. 9 is a flow chart illustrating a method of designing an IC chip that includes a voltage island according to an exemplary embodiment of the present invention.

FIG. 10 is a block diagram illustrating an IC chip that includes a voltage island.

FIG. 11 is a flow chart illustrating a method of designing an IC chip according to an exemplary embodiment of the present invention.

### DETAILED DESCRIPTION OF EXEMPLARY EMBODIMENTS

Exemplary embodiments of the present invention now will be described more fully with reference to the accompanying drawings. Like reference numerals refer to like elements throughout this application. It will be understood that when an element is referred to as being “connected” or “coupled” to another element, it can be directly connected or coupled to the other element or intervening elements may be present.

It is to be understood that the systems and methods described herein may be implemented in various forms of hardware, software, firmware, special purpose processors, or a combination thereof. In particular, at least a portion of the present invention is preferably implemented as an application comprising program instructions that are tangibly embodied on one or more program storage devices (e.g., hard disk, magnetic floppy disk, RAM, ROM, CD ROM, etc.) and executable by any device or machine comprising suitable architecture, such as a general purpose digital computer having a processor, memory, and input/output interfaces. It is to be further understood that, because some of the constituent system components and process steps depicted in the accompanying figures are preferably implemented in software, the connections between system modules (or the logic flow of method steps) may differ depending upon the manner in which the present invention is programmed. Given the teachings herein, one of ordinary skill in the related art will be able to contemplate these and similar implementations of the present invention.

FIG. 1 is a flow chart illustrating a method of simulating of a semiconductor integrated circuit (IC) at gate level according to an exemplary embodiment of the present invention.

Referring to FIG. 1, the method includes providing a net list including information about a variable power source and a variable ground source (step S110), providing a circuit model including the variable power source and the variable ground source (step S120), and simulating the net list by using the circuit model (step S130).

The net list includes the information about the variable power source and the variable ground source. Therefore, a result of the simulation may closely approximate a real operation of the circuit.

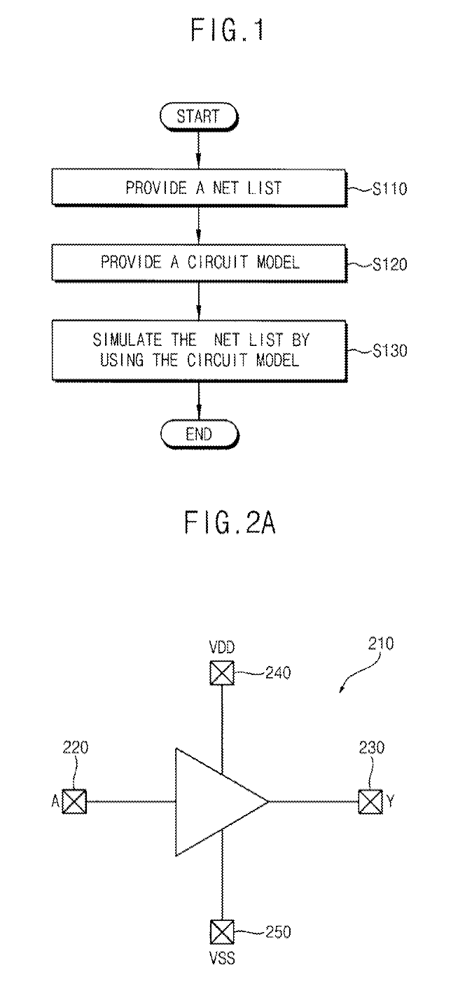

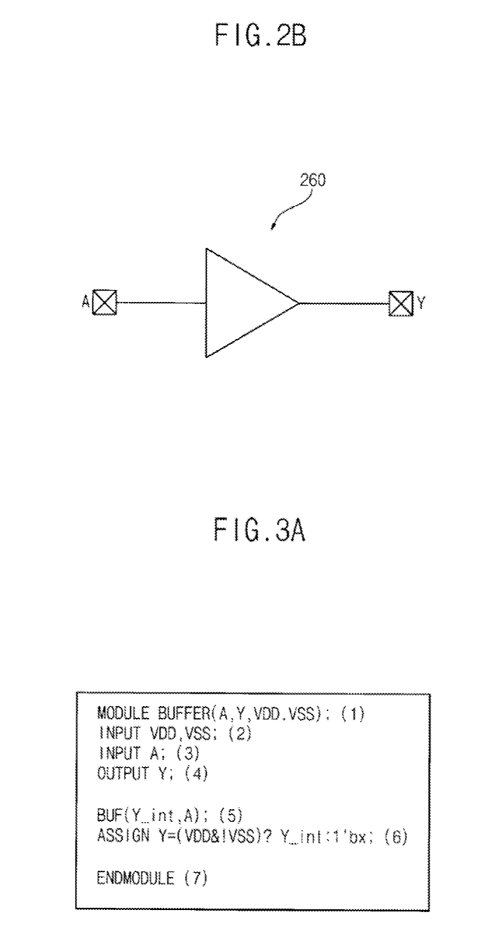

FIG. 2A is a diagram illustrating a circuit model of a buffer 210 that is powered by a variable power source and a variable ground source according to an exemplary embodiment of the present invention.

FIG. 2B is a diagram illustrating a circuit model of a buffer 260 that is not powered by a variable power source and a variable ground source for a comparison of the circuit model of FIG. 2B with the circuit model of FIG. 2B.

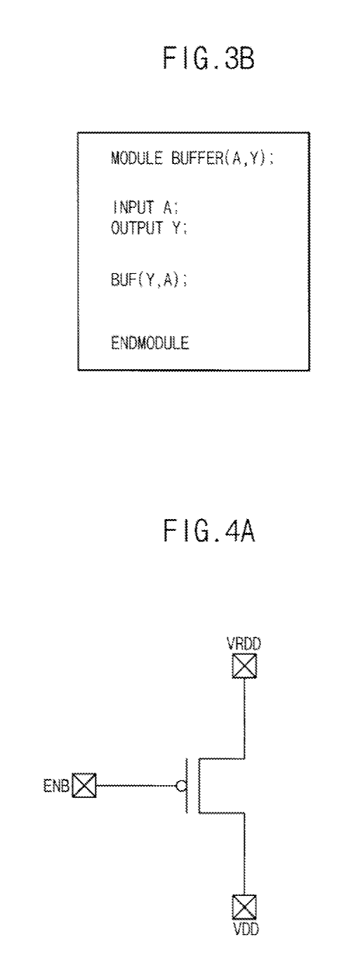

FIG. 3A is a diagram illustrating an example of Verilog Hardware Description Language (HDL) corresponding to the buffer of FIG. 2A.

FIG. 3B is a diagram illustrating an example of Verilog Hardware Description Language (HDL) corresponding to the buffer of FIG. 2B.

Referring to FIG. 2A, the buffer 210 includes an input port 220, an output port 230, a first power port 240, and a second power port 250. An input A is received at the input port 220, and an output Y is provided from the output port 230. A first power supply voltage VDD is applied to the first power port 240, and a second power supply voltage VSS or a ground voltage is applied to the second power port 250.

Referring to FIG. 3A, variables of the buffer 210 are defined on line (1) to describe the circuit model of FIG. 2A using Verilog HDL. The variables are divided into three groups, respectively on lines (2) through (4). The input A is set as Y_int on line (5). The output Y is updated to a value of Y_int or a value of 1′bx that may have a predetermined value, according to the first power supply voltage VDD and the second power supply voltage VSS on line (6), Here, the output Y is updated to the value of Y_int when (VDD & IVSS) is in a high state, and the output Y is updated to the value of 1′bx when (VDD & IVSS) is in a low state. Here, “&” corresponds to an AND operation and “!” corresponds to an NOT operation. The output Y is outputted by buffering the input A that corresponds to Y_int when the first power supply voltage VDD is in a high state and the second power supply voltage VSS is in a low state. The output Y is updated to the value of 1′ bx when the first power supply voltage VDD is in the low state or when the second power supply voltage VSS is in the high state. Accordingly, the output Y to may be outputted by buffering the input A or the output Y may be in a floating state. Very High Speed Specific Integrated Circuit Hardware Description Language (VHDL) may be used for the simulation instead of Verilog HDL.

Referring to FIGS. 2B and 3B, the buffer 260 and Verilog HDL do not include information about the variable power source and the variable ground. Therefore, an output Y is always outputted by buffering an input A. Accordingly, a result of the simulation of the IC chip may be erroneous in multi-power designs or power-gating designs.

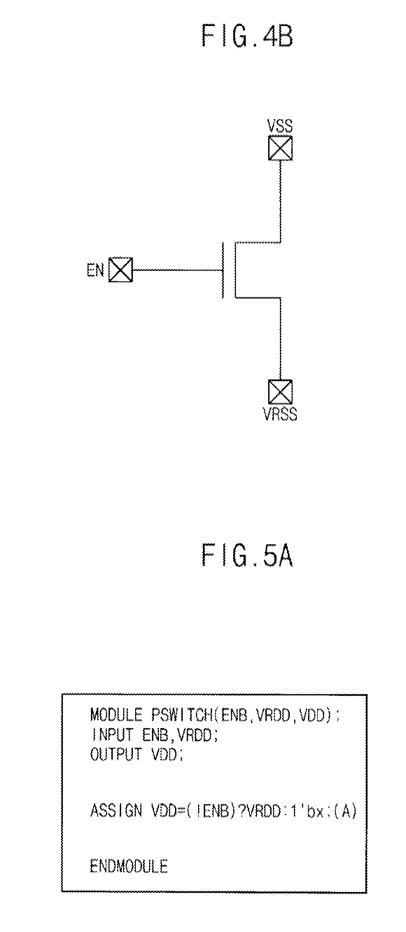

FIGS. 4A and 4B are diagrams illustrating circuit models of a p-type metal-oxide semiconductor (PMOS) switch and an n-type metal-oxide semiconductor (NMOS) switch according to exemplary embodiments of the present invention.

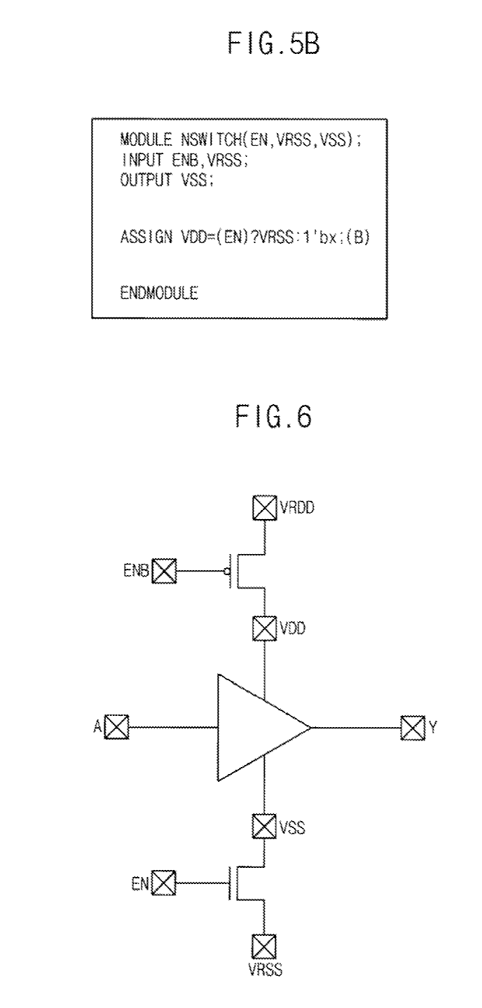

FIGS. 5A and 5B are diagrams illustrating examples of Verilog HDL corresponding to the PMOS switch and the NMOS switch of FIGS. 4A and 4B, respectively.

Referring to FIG. 4A, the first power supply voltage VDD is connected to a real power supply voltage VRDD or the first power supply voltage VDD may be in a floating state according to an enable bar signal ENB applied to the PMOS switch. The PMOS switch has a gate that receives the enable bar signal ENB, and a source that receives the real power supply voltage VRDD. The first power supply voltage VDD is updated to a value of the real power supply voltage VRDD when the enable bar signal ENB is in a low state. Alternately, the first power supply voltage VDD may be in a floating state when the enable bar signal ENB is in a high state.

Referring to FIG. 5A, the first power supply voltage VDD is updated to the value of the real power supply voltage VRDD when the enable bar signal ENB is in a low state on line (A). Alternately, the first power supply voltage VDD is updated to a value of 1′ bx when ENB is in a high state, where 1′ bx may have a predetermined value.

Referring to FIG. 4B, the second power supply voltage VSS is connected to a real ground voltage VRSS or the second power supply voltage VSS may be in a floating state according to an enable signal EN applied to the NMOS switch. The NMOS switch has a gate that receives the enable signal EN, and a source that receives the real ground voltage VRSS. The second power supply voltage VSS is updated to a value of the real ground voltage VRSS when the enable signal EN is in a high state. Alternately, the second power supply voltage VSS may be in a floating state when the enable signal EN is in a low state.

Referring to FIG, 5B, the second power supply voltage VSS is updated to the value of the real ground voltage VRSS when the enable signal EN is in a high state as on line (B). Alternately, the second power supply voltage VSS is updated to a value of 1bx when EN is in a low state, where 1′bx may have a predetermined value.

The PMOS switch and the NMOS switch are used for providing the real power supply voltage VRDD and the real ground voltage VRSS to the power voltage VDD and the second power supply voltage VSS, respectively.

FIG. 6 is a diagram illustrating a circuit model of the PMOS switch of FIG. 4A and the NMOS switch of FIG. 4B that are employed in the buffer of FIG. 2A. The circuit model of FIG. 6 may be described by using the Verilog HDLs that are illustrated in FIG. 3A, FIG. 5A, and FIG. 5B.

Referring to FIG. 6, the output Y may be outputted by buffering the input A or the output Y may be in a floating state, according to the first power supply voltage VDD and the second power supply voltage VSS whose states are determined based on the enable bar signal ENB and the enable signal EN, respectively.

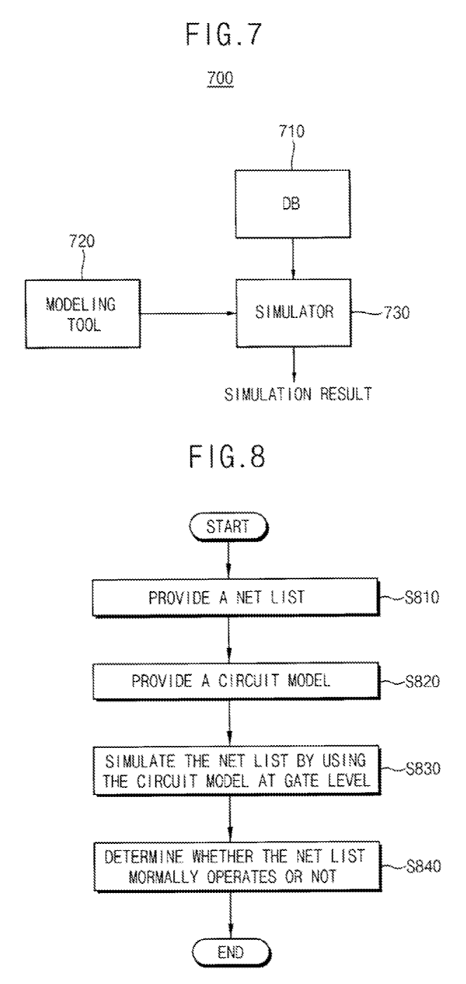

FIG. 7 is a block diagram illustrating an apparatus for simulating a semiconductor IC at gate level according to an exemplary embodiment of the present invention.

Referring to FIG. 7, the apparatus 700 includes a database 710, a modeling tool 720, and a simulator 730. The database 710 stores a net list including information about a variable power source and a variable ground source. The modeling tool 720 provides a circuit model including the variable power source and the variable ground source. The simulator 730 simulates the net list by using the circuit model.

The simulator 730 may simulate the buffer 210 of FIG. 2. The database 710 provides the net list including information about an input A, an output Y, a first power supply voltage VDD, and a second power supply voltage VSS. The modeling tool 720 provides the circuit model including the buffer 210 of FIG. 2A. The simulator 730 simulates the net list by using the circuit model including the buffer 210. The output Y is outputted by buffering the input A or the output Y in a floating state according to states of the first power supply voltage VDD and the second power supply voltage VSS as a result of the simulation. The apparatus 700 may be used for designs of multiple powers or designs of power-gating. Therefore, a result of a simulation may be correctly provided based on the states of the first power supply voltage VDD and the second power supply voltage VSS. The apparatus of FIG. 7 may be described by using Verilog HDL or VHDL.

FIG. 8 is a flow chart illustrating a method of designing an IC according to an exemplary embodiment of the present invention.

Referring to FIG. 8, the method of designing the IC includes providing a net list including information about a variable power source and a variable ground source (step S810), providing a circuit model including the variable power source and the variable ground source (step S820), simulating the net list by using the circuit model at gate level (step S830), and determining whether the net list is operating normally, based on a result of the simulation (step S840). The net list may be described by using Verilog HDL or VHDL. The simulation of the net list may be performed by using the method of FIG. 1. The IC may be designed based on the circuit model when the net list is determined to be operating normally. A design of the IC includes information about the variable power source and the variable ground source. Therefore, the IC may be designed based on a result of the simulation that better approximates a real operation of the IC.

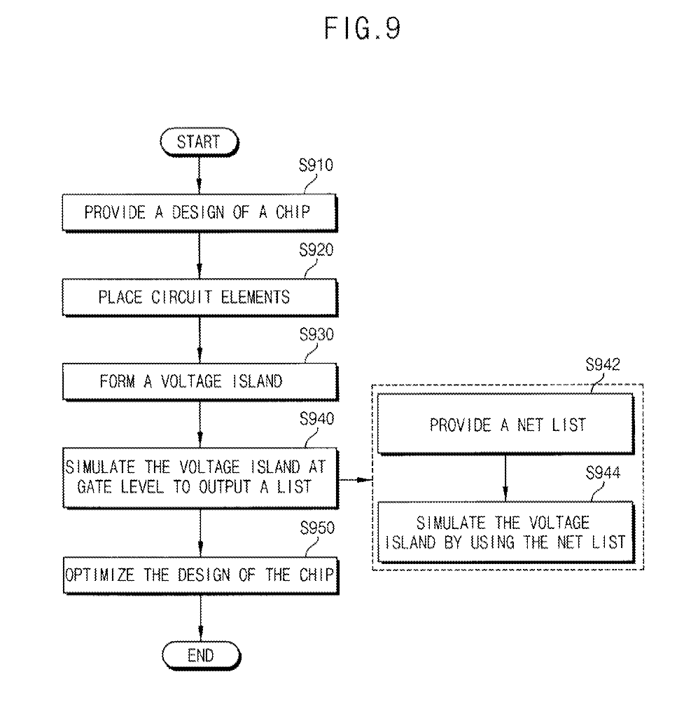

FIG. 9 is a flow chart illustrating a method of designing an IC chip that includes a voltage island according to an exemplary embodiment of the present invention.

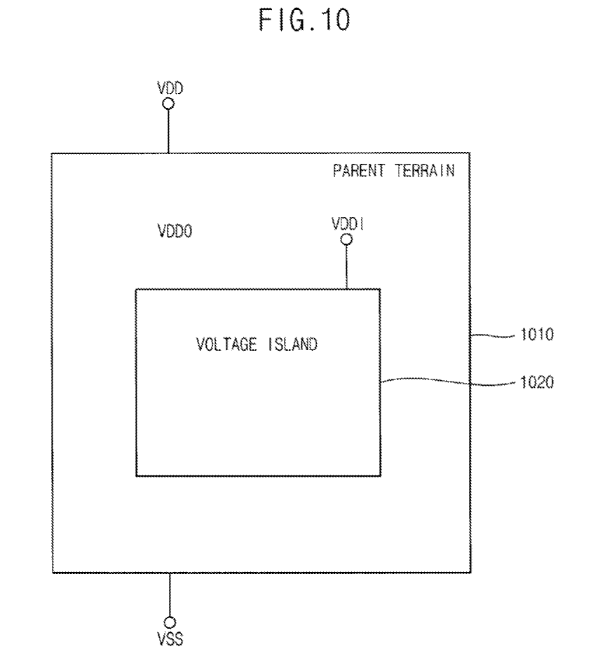

Referring to FIG. 9, the method of designing the IC chip including the voltage island includes providing a design for a variable power source and a variable ground source (step S910), forming at least one voltage island by partitioning elements of the IC chip design according to similarities in voltage requirements of the elements of the IC chip and timing of the variable power sources and the variable ground sources (step S930), simulating each voltage island at gate level to output a list including information about the voltage requirements and the timing of each voltage island (step S940), and optimizing the design of the IC chip based on the list (step S950). The method of designing the IC chip may further include placing circuit elements on the IC chip (step S920). Simulating each voltage island of step S940 may include providing a net list including information about the variable power source and the variable ground source (step S942), and simulating the voltage island by using the net list at gate level (step S944). The method of designing the IC chip will be described below with reference to FIG. 10.

FIG. 10 is a block diagram illustrating an IC chip that includes a voltage island. While one voltage island is included in the IC chip of FIG. 10, the present invention is not limited thereto, as two or more voltage islands may be included in the IC chip.

Referring to FIG. 10, the IC chip includes a parent terrain 1010 and a voltage island 1020 included in the parent terrain 1010. The IC chip receives a first variable power supply voltage VDD and a second variable power supply voltage VSS. The voltage island 1020 is formed by partitioning elements according to a voltage level that is required for elements of the IC chip and according to timing of the first variable power supply voltage VDD and the second variable power supply voltage VSS (step S930). The parent terrain 1010 receives a parent terrain voltage VDDO and the voltage island 1020 receives an island voltage VDDI. The list includes information about the voltage requirements and the timing of each voltage island. The list is outputted by simulating the voltage island 1020 and the design of the IC chip (step S940). The design of the IC chip is optimized based on the list (step S950). The design of the IC chip may be checked for power losses and abnormal operation.

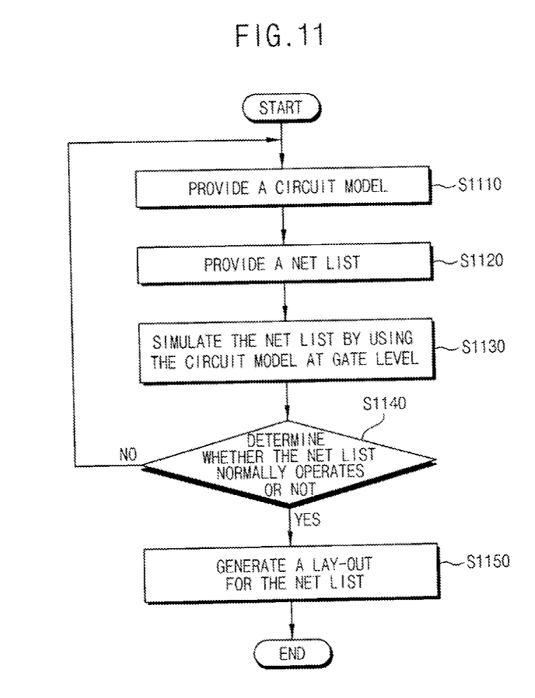

FIG. 11 is a flow chart illustrating a method of designing an IC chip according to an exemplary embodiment of the present invention.

Referring to FIG. 11, the method of designing the IC chip includes providing a circuit model including a variable power source and a variable ground source (step S1110), providing a net list including information about the variable power source and the variable ground source (step S1120), simulating the net list by using the circuit model at gate level (step S1130), determining whether the net list operates normally based on a result of the simulation (step S1140), and generating a lay-out for the net list when the net list is normally operating (step S1150). Step S1110 is executed after step S1140 when the net list is determined to be operating abnormally. The simulation may be performed by using Verilog HDL or VHDL. Additionally, a result of the simulation may be changed according to states of the variable power source and the variable ground source and the result of the simulation may be used for the design of the IC chip. Accordingly, the IC may be designed based on a result of the simulation that may more closely approximate a result of a real operation.

While exemplary embodiments of the present invention have been described in detail, it should be understood that various changes, substitutions and alterations may be made herein without departing from the scope of the invention.

What is claimed is:

1. A method of simulating a semiconductor integrated circuit (IC) at gate level, the method comprising:
providing a net list including information about a variable power source and a variable ground source;
providing a circuit model including the variable power source and the variable ground source; and
simulating the net list by using the circuit model at gate level.

2. The method of claim 1, further comprising determining whether the net list is operating normally based on a result of the simulating.

3. The method of claim 1, wherein a result of the simulating is based on states of the variable power source and the variable ground source.

4. The method of claim 1, wherein the simulating uses Verilog Hardware Description Language (HDL).

5. The method of claim 1, wherein the simulating uses Very High Speed Specific Integrated Circuit Hardware Description Language (VHDL).

6. A computer-readable medium embodying instructions executable by a processor to perform method steps for simulating a semiconductor integrated circuit (IC) at gate level, the method steps comprising:
providing a net list including information about a variable power source and a variable ground source;
providing a circuit model including the variable power source and the variable ground source; and
simulating the net list by using the circuit model at gate level;

7. An apparatus for simulating a semiconductor integrated circuit (IC) at gate level, the apparatus comprising:
a database configured to store information about a variable power source and a variable ground source;
a modeling tool configured to provide a circuit model including the variable power source and the variable ground source; and
a simulator configured to simulate a net list at gate level by using the circuit model.

8. The apparatus of claim 7, wherein an output of the simulator is based on states of the variable power source and the variable ground source.

9. The apparatus of claim 7, wherein the simulator uses Verilog Hardware Description Language (HDL).

10. The apparatus of claim 7, wherein the simulator uses Very High Speed Specific Integrated Circuit Hardware Description Language (VHDL).

11. A method of optimizing an integrated circuit (IC) chip, comprising:
providing a design of an IC chip including information about a variable power source and a variable ground source;
forming at least one voltage island by partitioning elements of the IC chip design according to similarities in voltage requirements of the elements of the IC chip and timing of the variable power sources and the variable ground sources;
simulating each voltage island at gate level to output a list including information about the voltage requirements and timing of each voltage island; and
optimizing the design of the IC chip based on the list.

12. The method of claim 11a further comprising:
placing circuit elements on the IC chip.

13. The method of claim 11, wherein the simulating each voltage island comprises:
providing a net list including information about a corresponding one of the variable power and ground sources; and
simulating the voltage island by using the net list at gate level.

14. The method of claim 11, wherein a result of the simulating of the voltage island is based on states of the corresponding one of the variable power and ground sources.

15. A method of designing an integrated circuit (IC) chip, comprising:
providing a circuit model including a variable power source and a variable ground source;
providing a net list including information about the variable power source and the variable ground source;
simulating the net list by using the circuit model at gate level;
determining whether the net list is operating normally based on a result of the simulating; and
to generating a lay-out for the net list when the net list is operating normally.

16. The method of claim 15, wherein a result of the simulating is based on states of the variable power source and the variable ground source.

17. The method of claim 15, wherein the simulating of the net list is performed by using Verilog Hardware Description Language (HDL).

18. The method of claim 15, wherein the simulating of the net list is performed by using Very High Speed Specific Integrated Circuit Hardware Description Language (VHDL).
